(19) United States
(12) Patent Application Publication
(10) Pub. No.: US 2023/0267541 A1
(43) Pub. Date: Aug. 24, 2023

(54) MESSAGE PROCESSING SERVER, PROGRAM AND MESSAGE PROCESSING METHOD

(71) Applicant: Nippon Telegraph and Telephone Corporation, Tokyo (JP)

(72) Inventors: Kaoru ARAI, Musashino-shi, Tokyo (JP); Hiroki SAKUMA, Musashino-shi, Tokyo (JP); Ryuta SUGIYAMA, Musashino-shi, Tokyo (JP)

(21) Appl. No.: 18/010,991

(22) PCT Filed: Jun. 25, 2020
(86) PCT No.: PCT/JP2020/024957

§ 371 Date: Dec. 16, 2022

(51) Int. Cl. G06Q 40/04

(52) U.S. Cl. CPC G06Q 40/04

(57) ABSTRACT

A message processing server includes a processing order determination unit configured to rearrange, among processing request messages with time stamps which are received in a predetermined reception period, processing request messages having the time stamps falling during a predetermined acceptance period in a clock time order of the time stamps, and a processing execution unit configured to process the processing request messages in a rearranged order. The above-described message processing server enables processing according to an order of the time stamps (transmission clock times) instead of an order of arrivals of the processing request messages.

### TECHNICAL FIELD

The present invention relates to a message processing server that processes a message to which a time stamp has been provided, a program, and a message processing method.

### BACKGROUND ART

As an example of distribution and usage of a highly precise and highly reliable clock time (clock time information), a time stamp has been proposed which is issued by a time authority that is a reliable third party (see Non-Patent Literatures 1 and 2). This time stamp includes a hash value of an electronic document, clock time information, and a signature of the time authority for a combination of the hash value and the clock time information. By verifying the signature, it is possible to certify the presence of the electronic document at a clock time indicated by the clock time information and non-alteration at and after the clock time. For example, in a case where the electronic document is a contract, since the time authority that is the reliable third party issues the time stamp, the presence of the contract on a date of the time stamp and the non-alteration on and after this date are secured.

As another example of the usage of the highly precise and highly reliable clock time is a method used for a clock time related to a record/log or trading/transaction. In a case where a plurality of devices obtain logs in a single system, as the record of the system, clock times (time stamps) in the logs need to be precise clock times by being synchronized between the devices. Moreover, for example, in trading where a plurality of participants are involved such as financial trading, precise transactional request placement clock times (transactional request clock times) are needed in a case where an order of transactions is determined according to an order of transactional request placements.

### CITATION LIST

### Non-Patent Literature

Non-Patent Literature 1: Scheme of Time-stamping, [online], Time Business Accreditation Center, [Searched on Jun. 10, 2020], the Internet <URL: https://www.dekyo.or.jp/tb/contents/summary/system 2.html >
Non-Patent Literature 2: Introducing Japan’s Time-stamping Technologies to the Global Market, NICT NEWS, [online], National Institute of Information and Communication Technology, [Searched on Jun. 10, 2020], the Internet <URL: https://www.nict.go.jp/publication/NICT-News/1007/01.html>

### SUMMARY OF THE INVENTION

### Technical Problem

In financial trading represented by stock trading, transactional request messages are processed in an order of arrivals at a server in an exchange. For this reason, a location physically close to the exchange with a short distance on a network to the server is advantageous. There is a possibility that even when a user (participant of a trading market) away from the server places a transactional request earlier in time, the transactional request message arrives at the server later than that of a user close to the server due to a network delay, so that a transaction order is reversed. In stock trading of recent years, high frequency trading has been performed, and a time difference in milliseconds or shorter is being affecting a profit. The transaction order is desirably determined according to the order of transactional request placements (transactional request placement clock times, transactional request clock times) instead of the order of arrivals (arrival clock times) at the server of transactional request placement/ transactional request/processing request messages to secure fairness for a network environment among the participants. In addition, it is anticipated that an exchange having the above-described scheme is supported by users (market participants), and such an exchange may gain still more participants.

The present invention has been made in view of the above-described background, and aims at enabling processing according to an order in which processing request messages have been transmitted/clock time order.

### Means for Solving the Problem

To solve the above-described problem, a message processing server according to the present invention includes a processing order determination unit configured to rearrange, among processing request messages with time stamps which are received in a predetermined reception period, processing request messages with the time stamps falling during a predetermined acceptance period in a clock time order of the time stamps, and a processing execution unit configured to process the processing request messages in a rearranged order.

### Effects of the Invention

According to the present invention, it is possible to enable the processing according to the order in which the processing request messages have been transmitted/clock time order.

### BRIEF DESCRIPTION OF DRAWINGS

FIG. 1 is a functional configuration diagram of a transaction server and transaction terminals according to the present embodiment.

FIG. 2 illustrates a configuration of a message spooler and a transaction processing spooler according to the present embodiment.

FIG. 3 is an explanatory diagram for describing a transfer delay time according to the present embodiment.

FIG. 4 is a graphic representation for describing a relationship between an acceptance period and a reception period according to the present embodiment.

FIG. 5 is a graphic representation for describing a temporal relationship between a plurality of acceptance periods and a plurality of reception periods according to the present embodiment.

FIG. 6 is a flowchart of overall processing to be executed by the transaction server according to the present embodiment.

FIG. 7 is a flowchart of message reception processing according to the present embodiment.

FIG. 8 is a flowchart of transaction processing according to the present embodiment.

FIG. 9 is a flowchart of window size determination processing according to the present embodiment.

FIG. 10 is a hardware configuration diagram illustrating an example of a computer configured to realize a function of the transaction server according to the present embodiment.

### DESCRIPTION OF EMBODIMENTS

Hereinafter, a transaction server (message processing server) according to an embodiment (embodiment mode) for carrying out the present invention will be described. The transaction server is configured to receive transactional request messages (processing request messages) from transaction terminals, and process the transactional request messages in an order of time stamps (transactional request clock times, transmission clock times) which are provided by the transaction terminals to the transactional request messages. To be more specific, the transaction server is configured to extract, from among transactional request messages received in a predetermined reception period, transactional request messages to which time stamps falling during a predetermined acceptance period (period in which the transactional request messages have been transmitted) have been provided, and process the extracted transactional request messages in ascending order of the time stamps.

The reception period is later in time than the acceptance period. A length of the acceptance period and a length of the reception period are determined according to transfer times (transfer delay times) of the transactional request messages from the transaction terminals to the transaction server. As a result, the transactional request messages with the time stamps falling during the acceptance period which have been transmitted from the transaction terminal in the acceptance period are supposed to be received by the transaction server until an end of the reception period. For this reason, the transaction server can process the transactional request messages in an order of transmission clock times (transactional request clock times, clock times of the time stamps) of the transactional request messages, and consequently, fairness among the users for a network environment can be secured. In addition, it is no longer necessary for the transaction terminals to concentrate in locations close to the transaction server, and the transaction terminals are distributed over a network. Thus, a delay difference between the transactional request messages is generated, and it is also possible to reduce load of the traffic which concentrates in a short amount of time.

### Overall Configuration

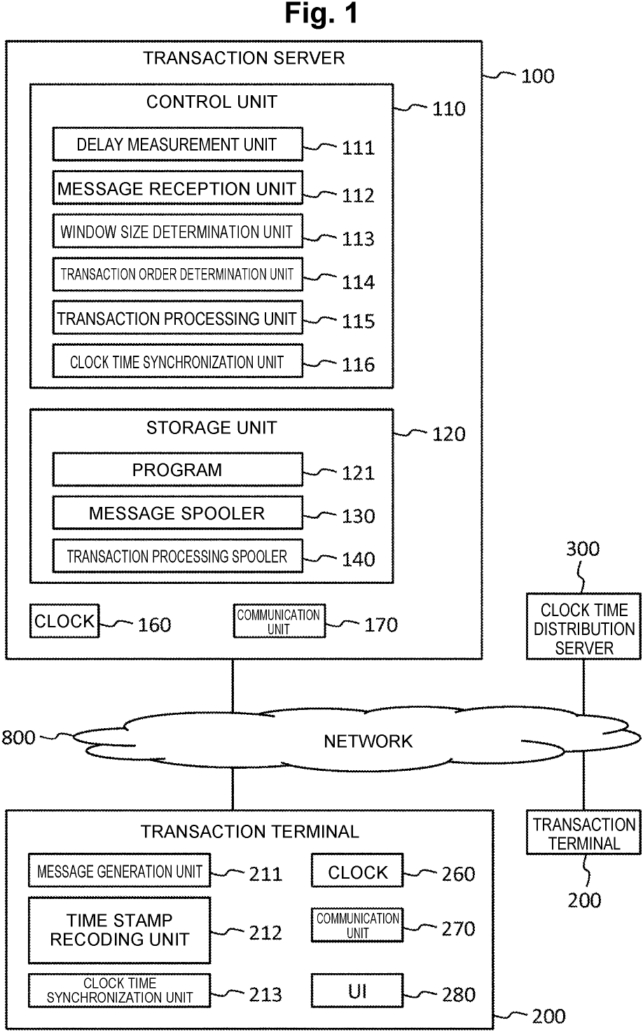

FIG. 1 is a functional configuration diagram of a transaction server 100 and transaction terminals 200 according to the present embodiment. The transaction server 100 and the transaction terminals 200 can communicate with each other via a network 800. FIG. 1 illustrates two of the transaction terminals 200, but many more of the transaction terminals 200 may be connected to the transaction server 100. A clock time distribution server 300 is further connected to the network 800, and distributes a clock time (performs clock time synchronization) to the transaction server 100 and the transaction terminal 200 using a protocol such as NTP (Network Time Protocol) or PTP (Precision Time Protocol).

### Configuration of Transaction Terminal

The transaction terminal 200 is a computer, and includes a control unit (not illustrated), a storage unit (not illustrated), a clock 260, a communication unit 270, and a user interface 280 (in FIG. 1, referred to as a UI). The communication unit 270 transmits and receives communication data with the transaction server 100 and the clock time distribution server 300. The user interface 280 includes a display, a keyboard, or the like, and is configured to display information related to a transactional request from the user of the transaction terminal 200, and accept an operation of the transactional request. The control unit is constituted by a CPU (Central Processing Unit), and includes a message generation unit 211, a time stamp recoding unit 212, and a clock time synchronization unit 213.

The clock time synchronization unit 213 synchronizes a clock of the clock time distribution server 300 with the clock 260 using the NTP, the PTP, or the like, and adjusts the clock 260 to a precise time.

The message generation unit 211 accepts a transactional request of a transaction from a user, and generates a transactional request message including transactional request contents.

The time stamp recoding unit 212 refers to the clock 260, and provides a current clock time to the transactional request message as a transactional request clock time. The time stamp recoding unit 212 may further provide a signature of the transaction terminal 200 or the user to the transactional request message. The transactional request message to which the time stamp (transactional request clock time) has been provided is transmitted to the transaction server 100 by the communication unit 270. The time stamp recoding unit 212 may provide a supposed transmission clock time instead of the current clock time as the time stamp.

### Configuration of Transaction Server

The transaction server 100 is a computer, and includes a control unit 110, a storage unit 120, a clock 160, and a communication unit 170. The communication unit 170 transmits and receives communication data with a transaction terminal 200 and a clock time distribution server 300.

The storage unit 120 is constituted by a ROM (Read Only Memory), a RAM (Random Access Memory), an HDD (Hard Disk Drive), an SSD (Solid State Drive), or the like. The storage unit 120 stores a program 121, a message spooler 130, a transaction processing spooler 140, or the like.

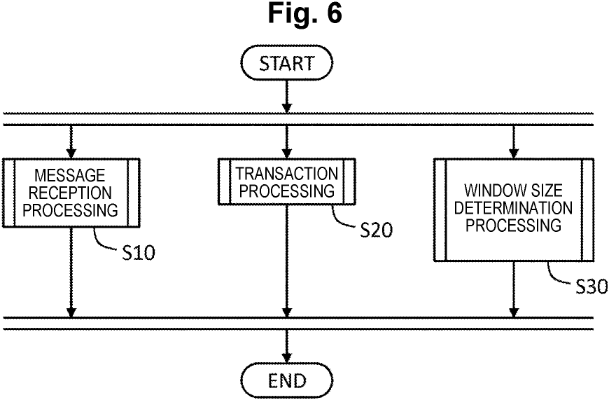

The program 121 controls the transaction server 100 that is a computer, and includes processing procedures of message reception processing, transaction processing, and window size determination processing illustrated in FIGS. 6 to 9 which will be described below.

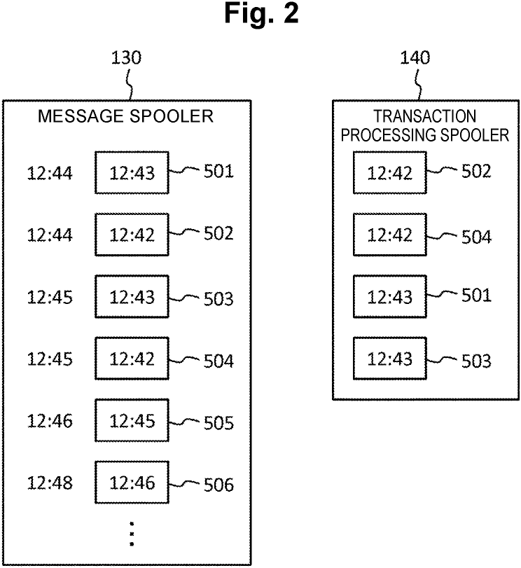

In the message spooler 130 (see FIG. 2 which will be described below), transactional request messages received by the communication unit 170 are stored in association with reception clock times.

Transactional request messages with time stamps falling during a predetermined acceptance period among the transactional request messages stored in the message spooler 130 are moved to the transaction processing spooler 140, and processed in an order of the time stamps (transactional request clock times) and then deleted.

FIG. 2 illustrates a configuration of the message spooler 130 and the transaction processing spooler 140 according to the present embodiment. In the message spooler 130, transactional request messages 501 to 506 are stored in association with reception clock times (arrival clock times at the transaction server 100) of the transactional request messages. In FIG. 2, time stamps (transactional request clock times) are respectively indicated in the transactional request messages 501 to 506. For example, the time stamp of the transactional request message 503 is “12:43” (12 minutes, 43 seconds), and the reception clock time is “12:45” (12 minutes, 45 seconds).

It is noted that in the following descriptions, a minimum unit of the time is a second, and the clock time is indicated in minutes and seconds. This is to facilitate the descriptions, and the minimum unit of the time may be, for example, a millisecond or 50 microseconds.

The transactional request messages with the time stamps falling during the acceptance period among the transactional request messages 501 to 506 stored in the message spooler 130 are moved to the transaction processing spooler 140. In FIG. 2, since the acceptance period is set from 12:42 to 12:43, the transactional request messages 502, 504, 501, and 503 are moved. It is noted that the moved transactional request messages are to be deleted from the message spooler 130, but for convenience of the descriptions in FIG. 2, it is illustrated as if the moved transactional request messages are stored in the message spooler 130.

### Configuration of Control Unit of Transaction Server

With reference to FIG. 1 again, the control unit 110 is constituted by a CPU, and includes a delay measurement unit 111, a message reception unit 112, a window size determination unit 113, a transaction order determination unit 114, a transaction processing unit 115, and a clock time synchronization unit 116.

The delay measurement unit 111 measures a transfer time (transfer delay time) of the transactional request message from the transaction terminal 200 to the transaction server 100. The delay measurement unit 111 may set a half of a round trip time of a communication packet between the transaction terminal 200 and the transaction server 100 as the transfer delay time, and may measure the transfer delay time utilizing the message used for the NTP or the PTP. Hereinafter, the delay measurement unit 111 measures the round trip time of the communication packet from and to the transaction terminal 200 multiple times, and determines a half of an average value of the measured round trip times as the transfer delay time of the transaction terminal 200.

The message reception unit 112 provides the reception clock time to the transactional request message from the transaction terminal 200 which has been received by the communication unit 170, and stores the transactional request message in the message spooler 130 (see FIG. 2).

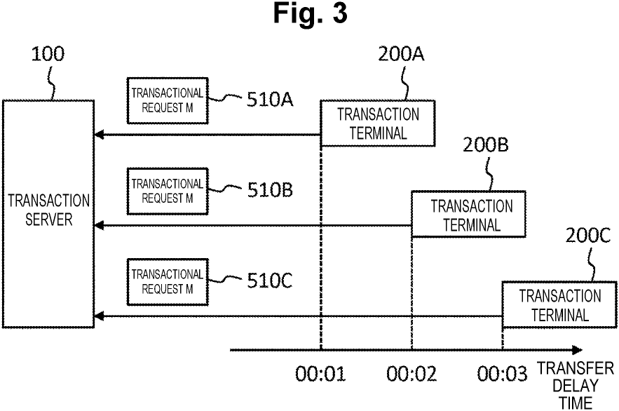

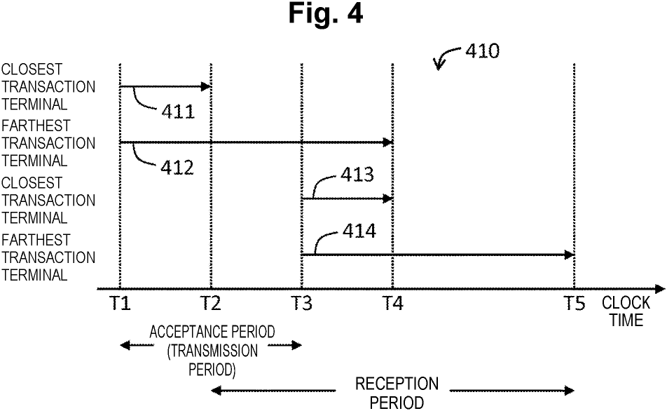

The window size determination unit 113 determines a length of the acceptance period and a length of the reception period. The window size determination unit 113 determines a reception period length (window size) based on a difference between a minimum transfer delay time and a maximum transfer delay time among the transfer delay times of the transaction terminals 200. It is noted that a relationship between the transfer delay time and the acceptance period and the reception period will be described below with reference to FIG. 3 and FIG. 4.

The transaction order determination unit 114 moves, to the transaction processing spooler 140, the transactional request messages with the time stamps falling during the acceptance period among the transactional request messages stored in the message spooler 130, and rearranges the transactional request messages in an order of the time stamps (from the earliest time stamp to the latest time stamp).

The transaction processing unit 115 processes, in the order of the time stamps, the transactional request messages which are stored in the order of the time stamps in the transaction processing spooler 140, and executes transactions of the transactional request contents included in the transactional request messages.

The clock time synchronization unit 116 synchronizes the clock of the clock time distribution server 300 with the clock 160 using the NTP, the PTP, or the like to adjust the clock 160 to the precise clock time.

### Relationship Between Transfer Delay Time and Acceptance Period and Reception Period

FIG. 3 is an explanatory diagram for describing a transfer delay time according to the present embodiment. Transfer delay times corresponding to times since transaction terminals 200A, 200B, and 200C transmit transactional request messages 510A, 510B, and 510C (in FIG. 3, referred to as a transactional request M) until the transaction server 100 receives the transmit transactional request messages are respectively 1 second, 2 seconds, and 3 seconds.

FIG. 4 is a graphic representation 410 for describing a relationship between an acceptance period and a reception period according to the present embodiment. An arrow 411 indicates that a transactional request message transmitted at a clock time T1 by the transaction terminal 200A closest to the transaction server 100 (see FIG. 3) has arrived at the transaction server 100 at a clock time T2. An arrow 412 indicates that a transactional request message transmitted at the clock time T1 by the transaction terminal 200C furthest from the transaction server 100 (see FIG. 3) has arrived at the transaction server 100 at a clock time T4. An arrow 413 indicates that a transactional request message transmitted at a clock time T3 by the transaction terminal 200A closest to the transaction server 100 has arrived at the transaction server 100 at the clock time T4. An arrow 414 indicates that a transactional request message transmitted at the clock time T3 by the transaction terminal 200C furthest from the transaction server 100 has arrived at the transaction server 100 at a clock time T5.

When the acceptance period of the transactional request messages is set as a period of the time stamps (transmission clock times) from the clock time T1 to the clock time T3, it is understood that the relevant transactional request messages arrive at the transaction server 100 during a period from the clock time T2 to the clock time T5. That is, to process the transactional request messages with the time stamps from the clock time T1 to the clock time T3, the transactional request messages with the relevant time stamps may be selected and processed from among the transactional request messages with the reception clock times from the clock time T2 to the clock time T5. For this reason, the window size determination unit 113 sets the reception period from the clock time T2 to the clock time T5.

A difference between the clock time T1 that is a start clock time of the acceptance period and the clock time T2 that is a start clock time of the reception period corresponds to the transfer delay time of the transaction terminal 200A closest to the transaction server 100. A difference between the clock time T3 that is an end clock time of the acceptance period and the clock time T5 that is an end clock time of the reception period corresponds to the transfer delay time of the transaction terminal 200C furthest from the transaction server 100.

In addition, a difference between the length of the reception period (reception period length) and the length of the acceptance period (acceptance period length) corresponds to a difference between a maximum value and a minimum value of the transfer delay times. The reception period length (window size) is larger than or equal to the difference between the maximum value and the minimum value of the transfer delay times.

This window size corresponds to a difference between the reception clock times (arrival clock times) at the transaction server 100 when the transaction terminal 200A closest to the transaction server 100 and the transaction terminal 200C furthest from the transaction server 100 transmit the transactional request messages in the acceptance period. In other words, by waiting for a window size time after the reception of the earliest transactional request message 510A transmitted in the acceptance period from the closest transaction terminal 200A, the latest transactional request message 510C transmitted in the acceptance period from the furthest transaction terminal 200C is to arrive at the transaction server 100.

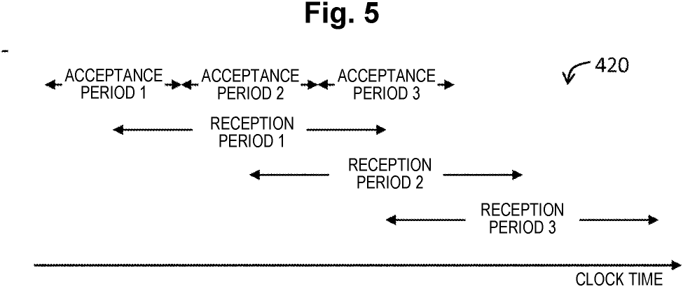

FIG. 5 is a graphic representation 410 for describing a temporal relationship between a plurality of acceptance periods and a plurality of reception periods according to the present embodiment. The transaction order determination unit 114 sequentially sections the time of the time stamps of the transactional request messages to be processed by the transaction processing unit 115 into an acceptance period 1, an acceptance period 2, and an acceptance period 3. The transaction order determination unit 114 moves, to the transaction processing spooler 140, the transactional request messages with the time stamps included in the acceptance period 1 among the transactional request messages having arrived during the reception period 1 corresponding to the acceptance period 1 among the transactional request messages stored in the message spooler 130, and rearranges the moved transactional request messages in the order of the time stamps. The transaction processing unit 115 processes the transactional request messages stored in the transaction processing spooler 140 in a rearranged order. The transaction order determination unit 114 and the transaction processing unit 115 repeat the above-described processing in the started order of the acceptance period 1, the acceptance period 2, and the acceptance period 3.

### Processing Procedure

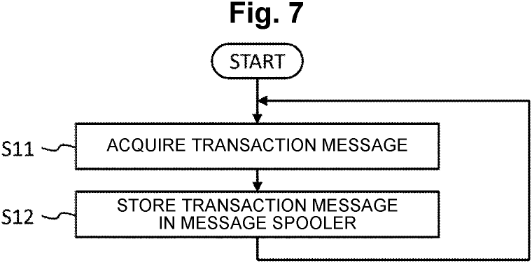

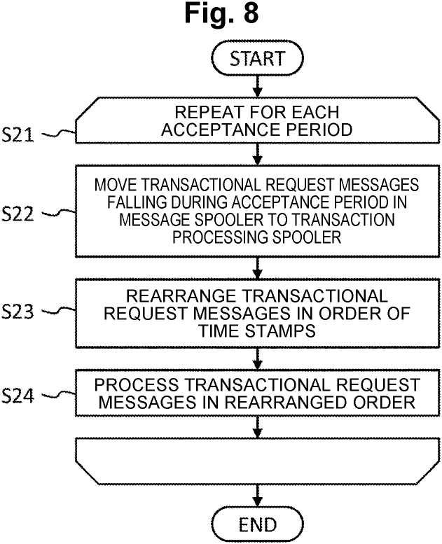

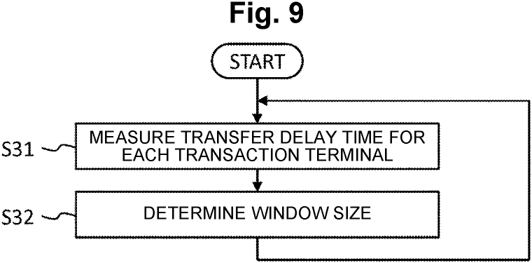

FIG. 6 is a flowchart of overall processing to be executed by the transaction server 100 according to the present embodiment. The control unit 110 of the transaction server 100 performs the message reception processing in step S10 (see FIG. 7 which will be described below), the transaction processing (see FIG. 8 which will be described below) in step S20, and the window size determination processing in step S30 (see FIG. 9 which will be described below) at the same time in parallel. It is noted that in the following descriptions, the acceptance period length is assumed to be previously set.

FIG. 7 is a flowchart of the message reception processing (see step S10 in FIG. 6) according to the present embodiment. The message reception processing is processing for repeating steps S11 and S12.

In step S11, the message reception unit 112 acquires the transactional request message received from the transaction terminal 200 which has been output by the communication unit 170.

In step S12, the message reception unit 112 provides the reception clock time to the transactional request message acquired in step S11, and stores the transactional request message in the message spooler 130.

FIG. 8 is a flowchart of the transaction processing (see step S20 in FIG. 6) according to the present embodiment. The transaction processing is processing for repeating steps S22 to S24 for each of the acceptance periods.

In step S21, the control unit 110 starts the processing for repeating steps S22 to S24 for each of the acceptance periods. To be more specific, the control unit 110 executes steps S22 to S24 at a time point at which the reception period (see FIG. 5) corresponding to the acceptance period has elapsed.

In step S22, the transaction order determination unit 114 moves, to the transaction processing spooler 140, the transactional request messages with the time stamps falling during the acceptance period among the transactional request messages stored in the message spooler 130.

In step S23, the transaction order determination unit 114 rearranges the transactional request messages stored in the transaction processing spooler 140 in the order of the time stamps (order from the earliest transactional request clock time to the latest transactional request clock time).

In step S24, the transaction processing unit 115 executes transaction processing on the transactional request messages stored in the transaction processing spooler 140 in the order rearranged in step S23.

FIG. 9 is a flowchart of the window size determination processing according to the present embodiment (see step S30 of FIG. 6). The window size determination processing is processing for repeating steps S31 and S32.

In step S31, the delay measurement unit 111 measures transfer delay times for the respective transaction terminals 200.

In step S32, the window size determination unit 113 sets the reception period length at a value obtained by adding the difference between the maximum transfer delay time and the minimum transfer delay time among the transfer delay times measured in step S31 to the acceptance period length.

### Feature of Transaction Server

The transaction server 100 collects, for each of the acceptance periods, the transactional request messages with the time stamps falling during the acceptance period among the received transactional request messages, and rearranges and processes the transactional request messages in the order of the time stamps. The reception period length of the transactional request messages set as the processing target is set from the difference between the maximum value and the minimum value of the transfer delay times of the transactional request messages from the transaction terminal. To be more specific, the reception period length is a length obtained by adding the difference between the maximum value and the minimum value of the transfer delay times of the transactional request messages to the acceptance period length. The transaction server 100 starts the processing after the maximum transfer delay time from the end clock time of the acceptance period. For this reason, the processing can be started after the reception of all the transactional request messages which have been transmitted up to the acceptance period by all the transaction terminals 200 including the transaction terminal 200 having the maximum transfer delay time. As a result, the transaction server 100 can sequentially process all the transactional request messages with the time stamps falling during the acceptance period. For this reason, the transaction server 100 can process the transactional request messages in the order of the transactional request placement clock times irrespective of distances in terms of the network of the transaction terminals 200. In addition, it is no longer necessary for the transaction terminals 200 to concentrate in the locations close to the transaction server 100, and the transaction terminals are distributed over the network. Thus, the delay difference between the transactional request messages is generated, and it is also possible to reduce the load of the traffic which concentrates in a short amount of time.

### Modified Example: Reception Period

The end clock time of the reception period is a clock time obtained by adding the maximum transfer delay time to the end clock time of the acceptance period. While a fluctuation of the transfer delay times is taken into account, the window size determination unit 113 may determine the end clock time of the reception period (reception period length). Although the transfer delay time is set at a half of an average of the round trip times of the communication packet measured multiple times, a predetermined time may be added to the transfer delay time. Alternatively, a constant multiple of a variance at the half of the round trip times (degree of change of the transfer delay times) may be added to the transfer delay time. As a result, the reception period length is extended. With this configuration, even when network congestion temporarily occurs to increase the transfer delay time and the transactional request message has arrived past the reception period in which the fluctuation is not taken into account, the transactional request messages can be processed in the order of the time stamps.

### Modified Example: Acceptance Period

In step S21, the transaction order determination unit 114 processes the transactional request messages with the time stamps falling during the acceptance period, but may process the transactional request messages with the time stamps prior to the acceptance period. In a case where the processing is performed as described above, even when the transactional request message has arrived with an unexpectedly severe delay at the transaction server 100 and has not been processed in the intended acceptance period, the transactional request message can also be processed though belatedly.

### Modified Example: Length of Acceptance Period

According to the above-described embodiment, the acceptance period length is previously set. As the acceptance period is shorter, the time since the transactional request message is received until the transactional request message is processed is shorter. That is, as the acceptance period is shorter, the reception period is also shorter, and the transactional request message is to be processed at a still earlier time after the transmission than before. In particular, the acceptance period is desirably shortened in the transaction in which high speed processing is desired.

### Modified Example: Measurement of Transfer Delay Time

According to the embodiment described above, the delay measurement unit 111 measures the transfer delay times related to all the transaction terminals 200. The delay measurement unit 111 may exclude, from the measurement target of the transfer delay time, the transaction terminal 200 that has not transmitted the transactional request message during a period of a predetermined length. In particular, in a case where the transfer delay time of the transaction terminal 200 excluded from the measurement target is longer than those of the other transaction terminals 200, the reception period length is shortened, and the transactional request messages are to be processed in a still earlier time after the transmission than before.

### Modified Example: Response to Suspicious Time Stamp

In a case where the arrival clock time of the transactional request message at the transaction server 100 is too early relative to the time stamp, the time stamp may be considered suspicious. To be more specific, a difference between the arrival clock time of the transactional request message and the time stamp is the transfer delay time of the transactional request message. In a case where this transfer delay time is significantly shorter than the transfer delay time measured by the delay measurement unit 111, the time stamp (transaction terminal 200) may be considered suspicious.

The message reception unit 112 may discard the transactional request message with the transfer delay time smaller than a predetermined value. The predetermined value includes a value obtained by subtracting a certain value from the transfer delay time measured by the delay measurement unit 111. Alternatively, the predetermined value may be a value obtained by subtracting a constant multiple of the variance from the average transfer delay time measured by the delay measurement unit 111. It is noted that instead of the message reception unit 112, the transaction order determination unit 114 may discard the suspicious transactional request message.

### Other Modified Examples

Some embodiments of the present invention have been described above, but these embodiments are for illustrative purposes and are not intended to limit a technical scope of the present invention. For example, the transaction server 100 moves the transactional request messages with the time stamps falling during the acceptance period among the transactional request messages stored in the message spooler 130 to the transaction processing spooler 140. In contrast, the transaction server 100 may process the transactional request messages with the time stamps falling during the acceptance period without performing the movement. In addition, the transaction server 100 processes the transactional request messages with the time stamps falling during the acceptance period after the rearrangement of the order of the time stamps, but may process the transactional request messages in the order of the time stamps without performing the rearrangement processing.

According to the embodiment described above, in the transaction terminal 200, the transactional request message is created, and the time stamp is provided. Instead of this, the transaction terminal may create and transmit a transactional request message to a gateway, and the gateway may provide a time stamp to the transactional request message and transmit the transactional request message to the transaction server. A market participant having a large number of transaction terminals such as a securities company may aggregate functions of providing the time stamps in the gateway.

According to the embodiment described above, the transaction server 100 executes the rearrangement processing of the transactional request messages and the transaction processing, but a plurality of servers may execute the rearrangement processing and the transaction processing.

According to the embodiment described above, the transaction server configured to process the transactional request messages in the order of the transmission clock times/transactional request clock times has been described by using the transactions as an example, but processing other than the transactions may be performed in the order of the transmission clock times/request clock times of the processing request messages.

The present invention can adopt various other embodiments, and furthermore, various alterations such as omissions and replacements can be made in a range without departing from the gist of the present invention. These embodiments and modifications thereof are included in the scope and the gist of the invention described in the present specification or the like, and also included in the invention described in the scope of claims and equivalents thereof.

### Hardware Configuration

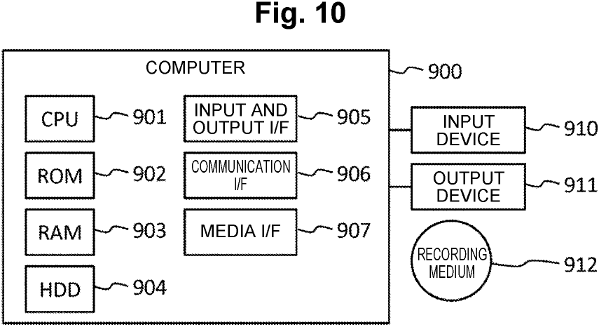

FIG. 10 is a hardware configuration diagram illustrating an example of a computer 900 configured to realize a function of the transaction server 100 according to the present embodiment. The transaction server 100 according to the present embodiment is realized by the computer 900 having a configuration as illustrated in FIG. 10, for example. The computer 900 includes a CPU 901, a ROM 902, a RAM 903, a hard disc drive 904 (referred to as an HDD in FIG. 10), an input and output interface 905 (referred to as an input and output I/F in FIG. 10), a communication interface 906 (referred to as a communication I/F in FIG. 10), and a media interface 907 (referred to as a media I/F in FIG. 10) .

The CPU 901 is configured to actuate based on a program stored in the ROM 902 or the hard disc drive 904, and perform control by the control unit 110 of FIG. 1. The ROM 902 stores a boot program to be executed by the CPU 901 at the time of activation of the computer 900, a program related to hardware of the computer 900, or the like.

The CPU 901 controls an input device 910 such as a mouse or a keyboard and an output device 911 such as a display or a printer via the input and output interface 905. The CPU 901 obtains data from the input device 910 and also outputs generated data to the output device 911 via the input and output interface 905.

The hard disc drive 904 stores a program to be executed by the CPU 901, data to be used by the program, or the like. The communication interface 906 receives data from another device which is not illustrated in FIG. 10 (for example, the transaction terminal 200, the clock time distribution server 300, or the like) via a communication network and outputs the data to the CPU 901, and also transmits the data generated by the CPU 901 to another device via the communication network.

The media interface 907 reads a program or data stored in a recording medium 912, and outputs the program or data to the CPU 901 via the RAM 903. The CPU 901 loads the program from the recording medium 912 onto the RAM 903 via the media interface 907, and executes the loaded program. The recording medium 912 is an optical recording medium such as a DVD (Digital Versatile Disk), an opto-magnetic recording medium such as an MO (Magneto Optical disk), a magnetic recording medium, a conductor memory tape medium, a semiconductor, or the like.

For example, in a case where the computer 900 functions as the transaction server 100 according to the present embodiment, the CPU 901 of the computer 900 executes the program 121 (see FIG. 1) loaded on the RAM 903 to realize the function of the transaction server 100. The CPU 901 reads the program from the recording medium 912 and executes the program. In addition to this, the CPU 901 may read a program from another device via the communication network, or may install the program 121 in the hard disc drive 904 from the recording medium 912 and execute the program.

### Advantages

Hereinafter, advantages of the transaction server 100 (message processing server) will be described.

The message processing server (transaction server 100) according to the present embodiment is characterized by including a processing order determination unit (transaction order determination unit 114) configured to rearrange, among processing request messages (transactional request messages) with time stamps which are received in a predetermined reception period, processing request messages having the time stamps falling during a predetermined acceptance period in a clock time order of the time stamps, and a processing execution unit (transaction processing unit 115) configured to process the processing request messages in a rearranged order.

In accordance with the message processing server described above, the processing request messages (transactional request messages) can be processed in the order of the time stamps (transmission clock times, transactional request clock times). Irrespective of the transfer delay times (distances in terms of the network) from the transmission sources (transaction terminals 200) to the message processing server, the processing request messages (transactional request messages) can be processed in the order of the transmission clock times of the processing request messages, and the fairness can be secured.

In addition, the message processing server is characterized by further including the delay measurement unit 111 configured to measure transfer delay times for respective transmission sources of the processing request messages, each of the transfer delay times corresponding to a time since the processing request message is transmitted until the processing request message is received by the message processing server, and a reception period length determination unit (window size determination unit 113) configured to set a length of the reception period according to the difference between a maximum value and a minimum value of the transfer delay times.

When the length of the reception period (reception period length) of the processing request messages is set as described above, irrespective of whether the processing request message is a processing request message with a long transfer delay time from the transmission source far from the message processing server or a processing request message with a short transfer delay time from the transmission source close to the message processing server, all the processing request messages transmitted during the acceptance period can be received by the message processing server, and processed in the order of the time stamps.

It is characterized in that the processing order determination unit sets the length of the reception period according to a degree of change of the transfer delay times.

In a case where the reception period length of the processing request messages is set as described above, even when the transfer delay time of the processing request message is extended more than usual due to the occurrence of the network congestion and so on, the processing request messages transmitted during the acceptance period can be received by the message processing server, and processed in the order of the time stamps.

It is characterized in that the processing order determination unit excludes, from a processing target, a processing request message having a smaller difference between the time stamp and the reception clock time of the processing request message than the value obtained by subtracting the predetermined value from the transfer delay time at the transmission source of the processing request message.

When the processing request message is excluded as described above, it is possible to avoid the processing on the processing request message to which the suspicious time stamp has been provided, and the fairness can be secured.

It is characterized in that the delay measurement unit 111 avoids measuring the transfer delay time with regard to the transmission source where the processing request message has not been transmitted during a period of a predetermined length.

When the transmission source of the measurement target for the transfer delay time of the processing request message is removed as described above, a case may arise when the reception period length of the processing request messages can be shortened, the processing request message is to be processed at a still earlier time after the transmission than before.

Reference Signs List

| | |
|---|---|
| 100 | Transaction server (message processing server) |
| 111 | Delay measurement unit |
| 112 | Message reception unit |
| 113 | Window size determination unit (reception period length determination unit) |
| 114 | Transaction order determination unit (processing order determination unit) |
| 115 | Transaction processing unit (processing execution unit) |
| 116 | Clock time synchronization unit |
| 130 | Message spooler |
| 140 | Transaction processing spooler |
| 200 | Transaction terminal (transmission source, transmission source of processing request message) |
| 501 to 506, 510A, 510B, 510C | transactional request message (processing request message) |

1. A message processing server comprising:
a processing order determination unit, including one or more processors, configured to rearrange, among processing request messages with time stamps which are received in a predetermined reception period, processing request messages having the time stamps falling during a predetermined acceptance period in a clock time order of the time stamps; and
a processing execution unit, including one or more processors, configured to process the processing request messages in a rearranged order.

2. The message processing server according to claim 1, further comprising:
a delay measurement unit, including one or more processors, configured to measure transfer delay times for respective transmission sources of the processing request messages, each of the transfer delay times corresponding to a time since the processing request message is transmitted until the processing request message is received by the message processing server; and
a reception period length determination unit, including one or more processors, configured to set a length of the reception period according to a difference between a maximum value and a minimum value of the transfer delay times.

3. The message processing server according to claim 2, wherein
the reception period length determination unit is configured to set the length of the reception period according to a degree of change of the transfer delay times.

4. The message processing server according to claim 2, wherein
the processing order determination unit is configured to exclude, from a processing target, a processing request message having a smaller difference between the time stamp of the processing request message and a reception clock time than a value obtained by subtracting a predetermined value from the transfer delay time at the transmission source of the processing request message.

5. The message processing server according to claim 2, wherein
the delay measurement unit is configured to avoid measuring the transfer delay time with regard to the transmission source where the processing request message has not been transmitted during a period of a predetermined length.

6. A non-transitory computer-readable storage medium storing program for causing a computer to function as a message processing server to perform operations comprising:
rearranging, among processing request messages with time stamps which are received in a predetermined reception period, processing request messages having the time stamps falling during a predetermined acceptance period in a clock time order of the time stamps; and
processing the processing request messages in a rearranged order.

7. A message processing method for a message processing server, the message processing server executing:
rearranging, among processing request messages with time stamps which are received in a predetermined reception period, processing request messages having the time stamps falling during a predetermined acceptance period in a clock time order of the time stamps; and
processing the processing request messages in a rearranged order.

8. The message processing method according to claim 7, further comprising:
measuring transfer delay times for respective transmission sources of the processing request messages, each of the transfer delay times corresponding to a time since the processing request message is transmitted until the processing request message is received by the message processing server; and
setting a length of the reception period according to a difference between a maximum value and a minimum value of the transfer delay times.

9. The message processing method according to claim 8, further comprising:
setting the length of the reception period according to a degree of change of the transfer delay times.

10. The message processing method according to claim 8, further comprising:
excluding, from a processing target, a processing request message having a smaller difference between the time stamp of the processing request message and a reception clock time than a value obtained by subtracting a predetermined value from the transfer delay time at the transmission source of the processing request message.

11. The message processing method according to claim 8, further comprising:
avoiding measuring the transfer delay time with regard to the transmission source where the processing request message has not been transmitted during a period of a predetermined length.

12. The non-transitory computer-readable storage medium according to claim 6, wherein the operations further comprise:
measuring transfer delay times for respective transmission sources of the processing request messages, each of the transfer delay times corresponding to a time since the processing request message is transmitted until the processing request message is received by the message processing server; and
setting a length of the reception period according to a difference between a maximum value and a minimum value of the transfer delay times.

13. The non-transitory computer-readable storage medium according to claim 12, wherein the operations further comprise:
setting the length of the reception period according to a degree of change of the transfer delay times.

14. The non-transitory computer-readable storage medium according to claim 12, wherein the operations further comprise:
excluding, from a processing target, a processing request message having a smaller difference between the time stamp of the processing request message and a reception clock time than a value obtained by subtracting a predetermined value from the transfer delay time at the transmission source of the processing request message.

15. The non-transitory computer-readable storage medium according to claim 12, wherein the operations further comprise:
avoiding measuring the transfer delay time with regard to the transmission source where the processing request message has not been transmitted during a period of a predetermined length.
